(19) United States
(12) Patent Application Publication
(10) Pub. No.: US 2009/0121388 A1
(43) Pub. Date: May 14, 2009

(54) Unit and Method for Compression Moulding Polymeric Articles

(75) Inventors: Maurizio Borgatti, Bologna (IT); Fiorenzo Parrinello, Bologna (IT)

Correspondence Address: BROWDY AND NEIMARK, P.L.L.C.;624 NINTH STREET, NW, SUITE 300, WASHINGTON, DC, 20001-5303, US

(73) Assignee: SACMI COOPERATIVA MECCANICI IMOLA SOCIETA' COOPERATIVA, IMOLA (IT)

(21) Appl. No.: 11/817,207

(22) PCT Filed: Feb. 21, 2006
(86) PCT No.: PCT/EP2006/001678

§ 371 Date: Aug. 27, 2007

(30) Foreign Application Priority Data
Mar. 1, 2005 (IT) RE2005100015

(51) Int. Cl. B29C 43/08

(52) U.S. Cl. 264/297.6; 264/297.5; 264/320; 425/110

(57) ABSTRACT

The unit comprises a moulding machine having a plurality of press moulds (N) for moulding the article, which operate in sequence and are driven along a fixed operative path (P), and a feeder means (20) located in a fixed position to the side of said operative path (P) to feed to each mould (N) at least one component part (8) of the article. According to the invention, a plurality of loading means (30) are provided, each rigidly associated with a respective mould (N) and movable with the mould along said operative path (P), said loading means (30) moving relative to the respective mould (N) to transfer one component part (8) at a time from the feeder means (20) to the mould (N). Each loading means (30) comprises a gripping head (31) for taking a component part (8) from the feeder means (20) and means for moving the gripping head (31), relative to the respective mould (N), between a first position (E1) in which the head (31) takes the component part (8) from the feeder means (20) and a second position (E2) in which said head (31) releases said component part (8) to the mould (N).

### TECHNICAL FIELD

The present invention relates to the compression moulding of articles of polymer material within moulds.

### BACKGROUND ART

In compression moulding articles of polymer material, it is known to use moulding machines which carry press moulds and move them along a fixed operative path along which the mould operates in sequence. Most moulding machines comprise a rotary turntable which carries the moulds along a circular operative path.

At least one component part of the article to be moulded is inserted into the mould by loading machines located in a fixed position to the side of the operative path; the component part can consist of a polymer part of defined mass (charge portion); in other cases two or more such charge portions can be provided, possibly together with a substantially rigid insert to be associated with the polymer mass.

If the moulds are moved continuously, the technical problem exists of transferring the component part (charge portion or insert) from the feeder means to the mould while this is moving.

For this purpose numerous different loading machines are currently known, all comprising a loading turntable with its axis of rotation external to the mould path, and in particular to the path of the loading machine turntable, which rotates in the same direction as these and presents a point or region tangential to the mould path, said component part being transferred to the mould as this slides along said tangency point or region. A drawback of said known loading machines is that the turntables necessarily have a usually large diameter; consequently the minimum distance between component part loading machines operating one after the other is likewise large (in this respect, these turntables must have their axes positioned a distance apart not less than the sum of their respective peripheral radii). As this insertion of the component parts by each of the two loading machines takes place within the region of tangency between the respective turntable and the mould operative path, between the two insertion regions an operative path portion exists in which mould operations do not take place and which is therefore superfluous to the moulding process, Consequently, if two component parts have to be inserted consecutively into the mould, the operative path must be lengthened by a substantially superfluous distance, with the result that, for the same production rate, the machine requires a larger number of correspondingly superfluous moulds, with consequent higher costs and larger space requirements.

Another problem occurs in those cases in which transfer of the component part to the mould requires a relatively lengthy time. This occurs in many cases, for example when the component part is a charge portion of relatively large mass, or when the charge portion is of viscous liquid consistency and tends to adhere to those parts with which it comes into contact, or if the operation is relatively complex, for example when transferring the component part into a precise position within the mould, or if the component part must be made rigid with the punch, etc.

In all these cases the loading machines have to be provided with particularly complex (and hence costly and complicated) transfer devices to enable the component part to follow a relatively lengthy mould path (usually a circular arc).

It has even been proposed to modify the mould carrying machine so that the moulds follow the (circular arc) path of the loading turntable, with the result that the moulding machine becomes even more complex, complicated and costly.

### DISCLOSURE OF THE INVENTION

An object of the present invention is to provide a unit and method for compression moulding articles of polymer material able to overcome said technical problems.

This and other objects are attained by the present invention as characterised in the claims.

The unit of the invention comprises a moulding machine having a plurality of press moulds in which the article is moulded and which operate in sequence, driven along a fixed operative path, and a feeder means located in a fixed position to the side of said operative path, to feed to each mould at least one component part of the article. The moulding machine comprises a plurality of loading means, each rigidly associated with a respective mould and movable with the mould along its operative path, and movable relative to it to transfer one component part at a time from the feeder means to the die or punch of the mould and release it thereto.

Each loading means comprises a gripping head for taking a component part from the feeder means and means for moving the gripping head, relative to the respective mould, between a first position external to the mould cavities, in which the head takes the component part from the feeder means, and a second position in which said head releases said component part to the die or punch of the mould.

The process of the invention consists of sequentially transferring component parts of the article by a feeder means located in a fixed position to a moulding machine comprising a plurality of press moulds in which the article is moulded, and which operate in sequence along a fixed operative path. According to the invention, the process comprises the steps of moving a plurality of loading means, each rigidly associated with a respective mould in such a manner as to move with it, to take one component part at a time from the feeder means and transferring said component part to the die or punch of the respective mould and releasing it thereat, by moving the loading means with a movement relative to the mould.

According to the invention, transfer of the component part from the feeder means to the mould takes place in two stages: the component part is firstly withdrawn from the feeder means at that point in which it is tangential to the path of the gripping head when located in its first end position, and only then is it transferred from this position to its second end position in which the component part is released to the mould. If, between the moment of withdrawal and the next moment for transfer to the mould, this is engaged in other operations (for example the machine is unloading the moulded articles), the loading means remains in a position external to the mould in order not to interfere with those members operating on the mould, and only subsequently does it transfer the part to the mould; this transfer can also be effected an instant before the subsequent operation is carried out. For example in the aforesaid case in which at least two component parts are to be inserted into the mould by successive turntable means, these two means do not have to be positioned close together; the first can even be positioned (evidently in a suitable place) some distance from the second; in this respect, the first component part can remain for a more or less lengthy time in an inoperative position until it becomes possible to insert it into the mould, which can conveniently take place an instant before the second component part is inserted. Consequently the position in which the first feeder means is located is (within reasonable limits) independent of the position and does not give rise to any superfluous portion of the operative path.

Moreover, as the loading means is located at the edge of the moulding machine it can operate on the respective mould along a very lengthy portion of its path if necessary, this being practically impossible in traditional continuously operating machines.

Finally, the loading means of the invention is of relatively simple and economical construction.

### BRIEF DESCRIPTION OF THE DRAWINGS

The invention is described in detail hereinafter with the aid of the accompanying figures which illustrate one embodiment thereof by way of non-exclusive example.

FIG. 1 is a schematic plan view of unit according to the invention.

FIG. 2 is an enlarged detail of FIG. 1, showing a mould component and a respective loading means.

FIG. 3 is a vertical elevation of FIG. 2.

FIG. 4 is an enlarged detail of FIG. 1 showing a machine and feeder means in which different moulds and their loading means are present.

FIG. 5 is a perspective view of the component part 8 to be handled by the loading means of FIG. 3.

### DETAILED DESCRIPTION OF THE INVENTION

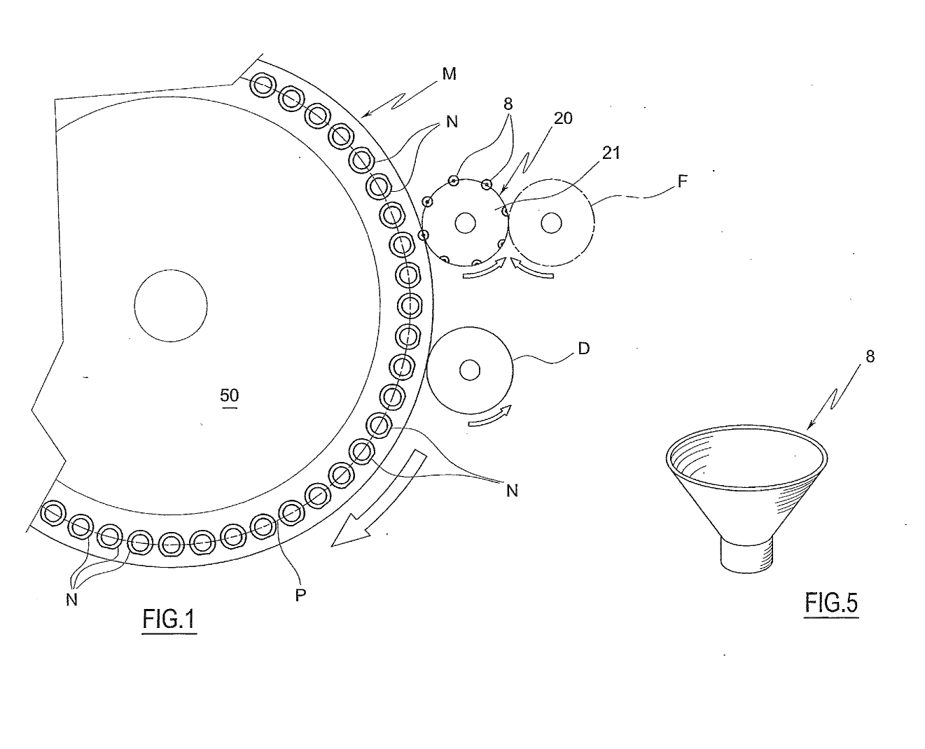

The machine shown in FIG. 1 and indicated by M is for compression moulding deformable tubular plastic containers, intended for packaging substances in paste form. Said machine comprises a plurality of press moulds, indicated by N and driven along a fixed operative path P. In particular, the machine M comprises a circular turntable 50 carrying the moulds N and driving them along a circular path P. The moulds N are operated in sequence along the path P, the article being moulded within them. The article moulding stage occupies only a small part of the operative path P; the larger part of this path is used for cooling the article after moulding.

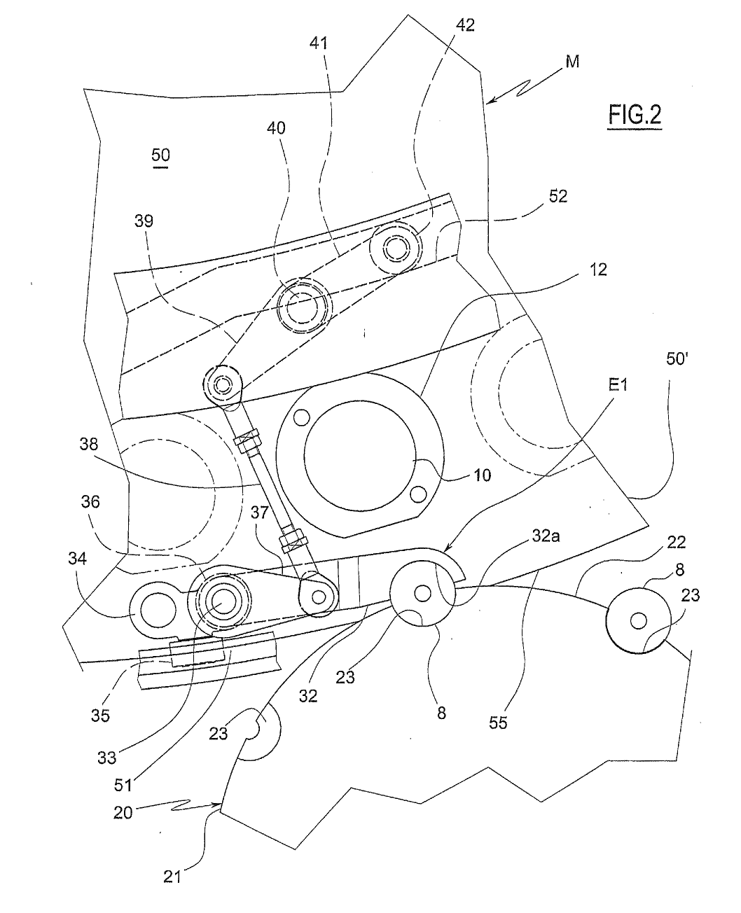

The loading means 30 shown in FIGS. 2-4 apply a component part 8, consisting in this case of an insert (shown in perspective view in FIG. 5), to the lower end 11 (head) of a vertical punch 10 which penetrates into the cavity of an underlying die (not shown in the figures).

In the illustrated example, the insert 8 is of relatively rigid material and is pressed into the mould N together with one or more plastic material charge portions inserted into the die; for this purpose the insert 8 is applied rigidly to the lower end 11, which is of complementary shape and matches the inner surface of the insert, which is then compressed into the die cavity into which one or more plastic charge portions have been inserted.

Said inserts 8 are firstly fed, by a rotary loading device F (of known type, shown only schematically in the figure), to a feeder means 20 located in a fixed position to the side of said operative path P, to feed the machine M. By way of example, downstream of the feeder means 20, to the side of the machine M, there is positioned a second device D (also on known type, shown only schematically in FIG. 1) for loading one charge portion at a time into the mould die, to then be pressed together with the insert 8, by known methods.

The function performed by the present invention in the embodiment shown in FIGS. 2-4 is to transfer one component part 8 at a time, originating from the loading device F, to the lower end 11 of each punch 10.

Said function is implemented by the feeder means 20 and a plurality of loading means 30 arranged to transfer one component part 8 at a time from the feeder means 20 to the respective mould N and acting in combination with the feeder means 20.

Each loading means 30 is associated rigidly with a respective mould N such as to be able to move with it along the operative path and be also movable relative to the mould N itself.

Each loading means 30 comprises a gripping head 31 for taking one component part 8 at a time from the feeder means 20 and which, in the embodiment shown in the figures, comprises an arm 32 having at its free end a concave seat 32a profiled to embrace the component part 8 through a circular arc of about 180 degrees, and also able to receive the part 8 as an exact fit. In practice, the seat 32a presents a concavity the surface of which reproduces through a sector of 180 degrees the outer surface of the component part 8.

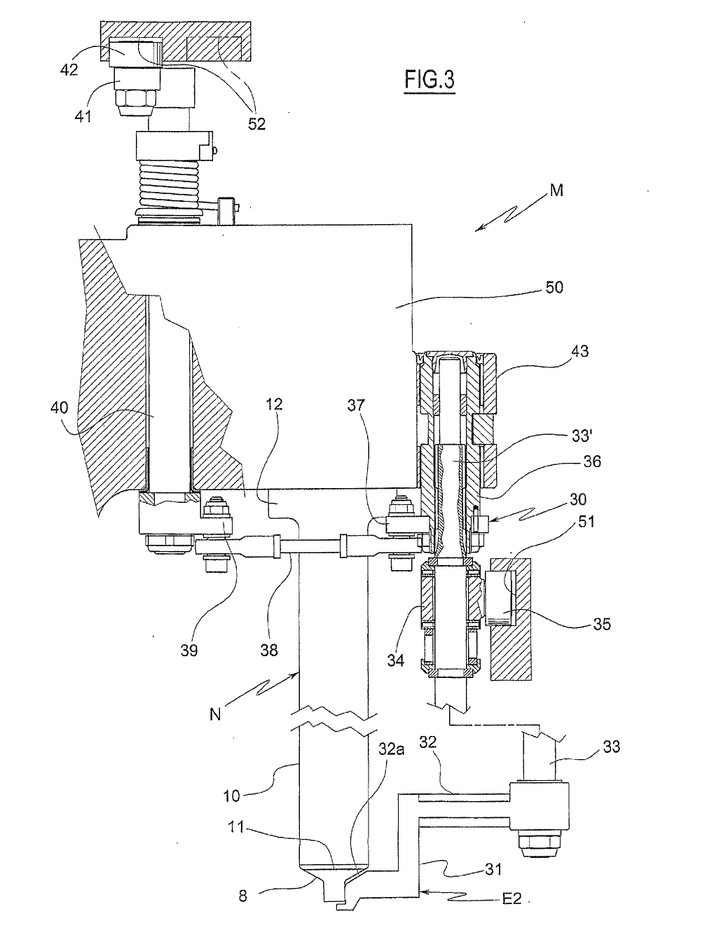

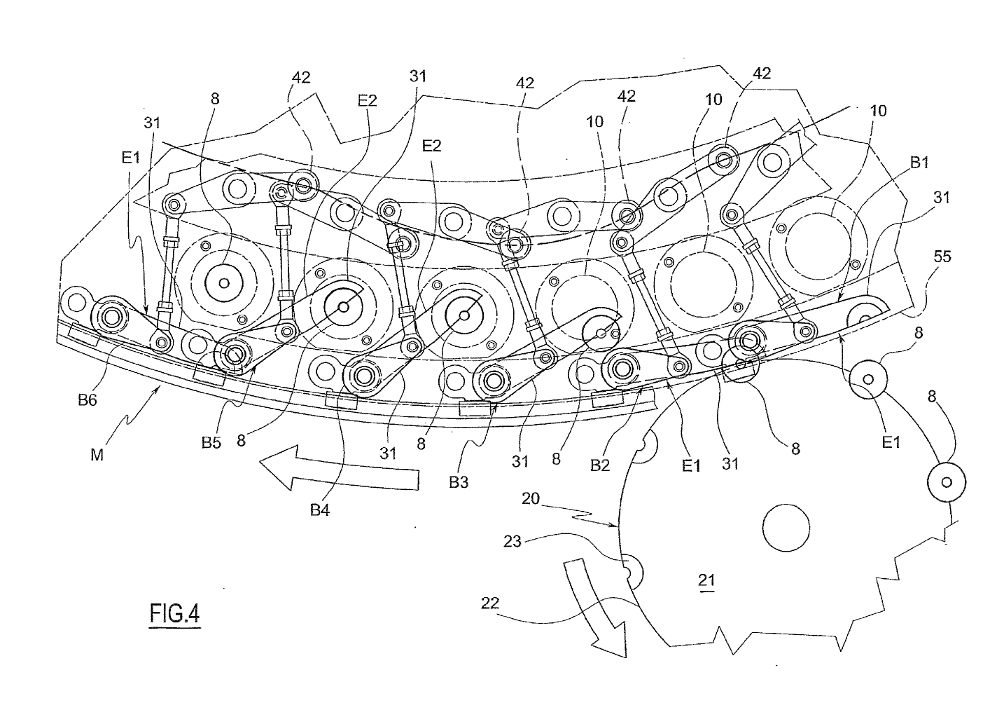

Each loading means 30 comprises means for moving the gripping head 31, relative to the respective mould N, between a first end position (shown in FIG. 2 and FIG. 4 and indicated by E1), in which the head 31 is located external to the mould cavities and is able to take the component part from the feeder means 20, and a second end position (shown in FIG. 3 and FIG. 4 and indicated by E2) in which the head is arranged to release the component part 8 to the mould N. and in particular by applying it to the lower end of the punch 10.

In detail, in the embodiment shown in the figures, the arm 32 is fixed to the lower end of a vertical rod 33 supported by a bush 34 to which it is constrained axially, whereas it is free to rotate about its axis. An idle wheel 35 is pivoted to the bush 34 on a horizontal axis radial to the axis of rotation of the turntable 50, to slide within a first fixed track 51 rigid with a peripheral portion 50′ of the turntable 50 extending through the entire circumference of this latter. The track 51 defines a path on a cylindrical surface the axis of which coincides with the axis of the turntable 50; this path deviates from the horizontal plane in the region in which the component part 8 is transferred onto the machine M, to cause vertical movements of the wheel 35 and, with them, corresponding vertical movements of the bush 34 and consequently of the rod 33 and arm 32. The upper portion 33′ of the rod 33, which projects upperly from the bush 34, is provided with axial grooves which engage in corresponding complementary grooves provided in the axial cavity of a hollow member 36; the rod 33 hence rotates rigid with the member 36 whereas it is free to slide axially thereto. By means of bushes 43, the hollow member 36 is constrained to the peripheral portion 50′, it being free only to rotate about its axis.

The punches 10 possess circular feet 12, fixed to the lower surface of the peripheral portion 50′.

A horizontal lever arm 37 is rigidly fixed to the hollow member 36 and is driven, via a connecting rod 38, by a second lever arm 39 fixed to the lower end of a second vertical rod 40, carried by the peripheral portion 50′ to which it is constrained, being free only to rotate about its axis.

To the upper end of the rod 40 there is fixed a third lever arm 41, to the free end of which there is pivoted an idle wheel 42 of vertical axis which slides within a second fixed track 52 also rigid with the peripheral portion 50′, which extends through the entire circumference of the machine M. The track 52 defines a path lying in a horizontal plane, which deviates from the circular line in the region where the component part 8 is transferred onto the machine M, to cause horizontal radial movements of the wheel 35 and, with them, corresponding oscillations of the lever arm 41 about the axis of the rod 40.

The oscillations of the lever 41 determine corresponding oscillations of the lever arm 39 and, via the connecting rod 38 and the lever arm 37, corresponding oscillations of the rod 33 about its axis, itself determining equal oscillations of the arm 32 of the gripping head 31, again in a horizontal plane.

Simultaneously with said oscillations, the rod 33 undergoes vertical oscillations by virtue of the profile of the first track 51, and with it the gripping head 31.

The rod 40, the relative lever arms 39 and 41, the connecting rod 38, the lever arm 37 and the hollow member 36 define a first mechanism, operated by the wheel 42 movable along the fixed track 52, which moves the gripping head 31 in the horizontal plane. The rod 33 and the bush 34 define a second mechanism, operated by the wheel 35 movable along the fixed track 52 and connected to the first mechanism, to move the gripping head 31 vertically.

The feeder means 20 comprises a rotary turntable 21 of vertical axis which carries on its periphery a plurality of concave housings 23, orientated centrifugally, each arranged to contain a component part 8; the surface of these housings 23 has substantially the same shape as the seats 32a of the head 31.

Said relative first end position E1 of the gripping head 31 lies on the periphery of the turntable 50, along a path tangential to the periphery of the turntable 21 of the feeder means 20, external to the cavities of the moulds N (FIGS. 2 and 4). The turntable 21 is made to rotate such that its peripheral speed is equal to and in the same direction as the peripheral speed of the gripping head 31 when in said first relative position E1, moreover the positions of the housings 23 are in geometrical relationship with the positions of the gripping heads 31 when in the first position E1, such that each housing 23 coincides with a gripping head 31 at the point of tangency.

FIG. 4 shows a series of different angular positions (indicated by B1, B2, . . . B6) assumed by the loading means during its path about the axis of the turntable 50, while it transfers one component part 8 at a time from the feeder means to the respective mould N.

Said transfer takes place in the following manner.

The turntable 50 and the turntable 21 both rotate in the same direction at the same peripheral speed referred to said first relative end position E1, Before the loading means 30 reaches the point of tangency with the turntable 21 (angular position B1), the arms 32 are maintained in a position virtually tangential to the peripheral line 55 of the turntable 50, and the relative seats 32a are aligned with this line 55, i.e. in said relative end position E1. During this stage the seats 32a are empty, while the housings 23 of the feeder means 20 positioned upstream of the point of tangency each contain a component part 8 which they retain for example by the action of air suction means (of known type not show in the figures). Said relative end position E1 is also maintained in the next angular position B2, where the peripheral line 55 of the turntable 50 is tangential to the turntable 21. In this stage the part 8 carried by the turntable 21 penetrates into the seat 32a without slippage, with a movement similar to that of a tooth of a gearwheel which penetrates into the corresponding recess of the other gearwheel, in the case of two meshing gearwheels. On penetrating into the seat 32a, the part 8 is gripped by the head 31, for example by the action of air suction means (of known type, not shown in the figures), and at the same time is released from the gripping means of the feeder means 20.

In the next angular position of the loading means 30 (indicated by B3), the gripping head 31 begins to move from said first relative end position by moving radially towards the mould axis, in particular towards the punch 10.

In the fourth angular position (indicated by B4), the gripping head 31 has been brought with its seat 32a on the punch axis, and then (fifth angular position, indicated by B5) the seat 32a is raised vertically to apply as an exact fit the component part 8 to the lower end 11 of the punch (second relative end position E2).

In the last illustrated angular position (indicated by B6), the head 31 has returned to the first relative end position E1, external to the mould N, and remains thereat until it returns to the described first angular position B1. The angular path travelled by the mould during the described transfer cycle for the part 8 from the feeder means 20 to the mould can be of considerable length; because of this, relatively complex transfer movements requiring relatively lengthy times can be carried out, as in the case of the transfer illustrated in the figures, which otherwise would be difficult to achieve in continuously operating machines using traditional means.

Moreover, when the gripping head 31 is in said first relative end position E1, it lies outside the mould cavity and does not hinder other possible operations taking place on the mould; consequently the position in which the feeder means 20 is located is independent of the position in which the final transfer of the part 8 to the mould N takes place.

An important consequence is that an operation which has to be performed before another is carried out can be done with a feed turntable positioned relatively far downstream of the next loading machine, without this requiring a corresponding increase in the length of the mould path of the machine M for performing the first operation. If for example, immediately after mounting the insert 8 onto the end of the punch II in the machine shown in the figures, a second part (for example a charge portion) has to be inserted into the mould cavity by a device D (FIG. 1), to then press the insert 8 and this charge portion together, the feeder means 20 can be positioned even at a considerable distance from the device D; in this respect, during the stage in which the gripping head 31 withdraws the part 8 and loads it onto the machine M by moving into the position E1, the gripping head 31 does not hinder other preliminary operations (for example mutual withdrawal between die and punch or discharge of articles from the machine), which can therefore be done simultaneously. As soon as said preliminary operations end and the part 8 has to be applied to the lower end 11 of the punch, the gripping head 31 is moved into said second relative end position E2, which can advantageously take place while the mould on which the head 31 is operating is positioned close to the point of tangency between the device D and the turntable 50 just before a charge portion is inserted into the mould cavity by the device D.

The result is that no superfluous extension length to the mould path need be provided, as instead is necessary in the traditional art.

Numerous modifications of a practical and applicational nature can be made to the invention, but without leaving the scope of the inventive idea as claimed below.

1. A unit for compression moulding articles of polymer material, comprising a moulding machine having a plurality of press moulds (N) for moulding the article, which operate in sequence and are driven along a fixed operative path (P), and a feeder means (20) located in a fixed position to the side of said operative path (P) to feed to each mould (N) at least one component part (8) of the article
characterised by comprising a plurality of loading means (30), each rigidly associated with a respective mould (N) and movable with the mould along said operative path (P), said loading means (30) moving relative to the respective mould (N) to transfer one component part (8) at a time from the feeder means (20) to the mould (N) and release it thereat.

2. A unit as claimed in claim 1, characterised in that each loading means (30) comprises a gripping head (31) for taking a component part (8) from the feeder means (20), and means for moving the gripping head (31), relative to the respective mould (N), between a first position (E1) in which the head (31) takes the component part (8) from the feeder means (20) and a second position (E2) in which said head (31) releases said component part (8) to the mould (N).

3. A unit as claimed in claim 2, characterised in that the feeder means (20) comprises a rotary turntable (21) of vertical axis which carries on its periphery a plurality of housings (23) each able to contain a component part (8), said first end position (E1) of the gripping head (31) lying on the periphery of the machine (M), along a path tangential to the periphery of the turntable (21) of the feeder means (20), the peripheral speed of the turntable (21) being equal to and in the same direction as the peripheral speed of the gripping head (31) when in said first position (E1), the positions of the housings (23) being in geometrical relationship with the positions of the gripping heads (31) when in the first position (E1), such that each housing (23) coincides with a gripping head (31) at the point of tangency.

4. A unit as claimed in claim 2, characterised in that said first position of the loading means (30) lies external to the mould cavities.

5. A unit as claimed in claim 3, characterised in that said means for moving the gripping head (31) comprise a first mechanism (36, 37, 38, 39, 40, 41) operated by a wheel (42) movable along a fixed track (52), to horizontally move the gripping head (31).

6. A unit as claimed in claim 5, characterised by comprising a second mechanism (33, 34) connected to the first mechanism, to vertically move the gripping head (31).

7. A process for sequentially transferring component parts of the article by a feeder means (20) located in a fixed position, to a moulding machine (M) comprising a plurality of press moulds (N) in which the article is moulded, and which operate in sequence along a fixed operative path (P), comprising the steps of moving a plurality of loading means (30), each rigidly associated with a respective mould (N), along the operative path (P) of the moulds (N), to take one component part (8) at a time from the feeder means (20), and of transferring it to the respective mould (N) by moving the loading means (30) with movement relative to the mould (N).

8. A process as claimed in claim 7, wherein the feeder means (20) comprises a rotary turntable (21) the periphery of which is tangential to the moulding machine (M), and which carries on its periphery a plurality of housings (23) each arranged to contain a component part (8),
characterised by comprising the steps of moving the feed turntable (21) along a path tangential to the periphery of the moulding machine (M) with a peripheral speed equal to and in the same direction as the peripheral speed of the gripping head (31), to bring each housing (23) into coincidence with a gripping head (31) of a respective loading means (30) positioned on the machine, and operating said gripping head (31) such as to withdraw the component part (8) while said coincidence remains.
